(19) United States
(12) Patent Application Publication
(10) Pub. No.: US 2006/0012304 A1
(43) Pub. Date: Jan. 19, 2006

(54) Plasma display panel and flat lamp using oxidized porous silicon

(76) Inventors: Seung-hyun Son, Hwaseong-si (KR); Hidekazu Hatanaka, Seongnam-si (KR); Young-mo Kim, Suwon-si (KR); Ho-nyeon Lee, Seongnam-si (KR); Sang-hun Jang, Yongin-si (KR); Seong-eui Lee, Seongnam-si (KR); Hyoung-bin Park, Seongnam-si (KR); Gi-young Kim, Yongin-si (KR)

Correspondence Address: MCGUIREWOODS, LLP, 1750 TYSONS BLVD, SUITE 1800, MCLEAN, VA, 22102, US

(21) Appl. No.: 11/178,493

(22) Filed: Jul. 12, 2005

(30) Foreign Application Priority Data
Jul. 13, 2004 (KR) 10-2004-0054488
Dec. 9, 2004 (KR) 10-2004-0103670

(51) Int. Cl. H01J 17/49

(52) U.S. Cl. 313/586; 313/587

(57) ABSTRACT

A plasma display panel (PDP) and a flat lamp. The PDP includes an upper panel and a lower panel facing each other, a plurality of address electrodes formed in the lower panel, a plurality of sustaining electrodes formed in the upper panel, and an oxidized porous silicon layer formed in the upper panel and corresponding to a sustaining electrode.

### CROSS REFERENCE TO RELATED APPLICATIONS

This application claims priority to and the benefit of Korean Patent Application No. 10-2004-0054488, filed on Jul. 13, 2004, and Korean Patent Application No. 10-2004-0103670, filed on Dec. 9, 2004, which are hereby incorporated by reference for all purposes as if fully set forth herein.

### BACKGROUND OF THE INVENTION

1. Field of the Invention

The present invention relates to a plasma display panel (PDP) and a flat lamp, and more particularly, to a PDP and a flat lamp using oxidized porous silicon to increase an electron-emitting characteristic.

2. Discussion of the Background

Generally, PDPs, which form an image using a gas discharge, may have excellent display characteristics such as high luminance and a wide viewing angle. Hence, their popularity is increasing. In PDPs, applying a direct current (DC) or alternating current (AC) voltage to electrodes may cause a gas discharge between the electrodes, thereby generating ultraviolet rays that excite a fluorescent material, which emits visible light.

PDPs may be DC or AC type PDPs according to the type of discharge. DC type PDPs include electrodes that are exposed in a discharge space, and electrical charges may move directly between electrodes. In AC type PDPs, a dielectric layer covers at least one of electrodes, and discharge occurs by wall charges formed on the dielectric layer rather than by direct movement of electrical charges between electrodes.

PDPs may also be facing discharge or surface discharge type PDPs according to electrode arrangement. In facing discharge type PDPs, one electrode of a sustaining electrode pair is formed on an upper substrate and the other is formed on a lower substrate. Here, a gas discharge occurs in a vertical direction to the substrates. In surface discharge type PDPs, the pair of sustaining electrodes is formed on the same substrate, and a gas discharge occurs in a direction that is parallel with the substrate.

While the facing discharge type PDP may have high luminous efficiency, plasma may easily deteriorate a fluorescent layer. Hence, surface discharge type PDPs are typically used.

FIG. 1 shows a conventional surface discharge AC PDP. FIG. 2A and FIG. 2B are cross-sectional views showing the PDP of FIG. 1, in a cross direction and in a length direction, respectively.

Referring to FIG. 1, FIG. 2A, and FIG. 2B, the conventional PDP may include an upper substrate 20 and a lower substrate 10 that face each other and are spaced apart by a predetermined distance. A plasma discharge occurs in a discharge space, which is a space between the upper substrate 20 and the lower substrate 10.

A plurality of stripe-shaped address electrodes 11 may be arranged on the top surface of the lower substrate 10, and a first dielectric layer 12 covers the address electrodes 11. A plurality of barrier ribs 13, which prevent electrical and optical cross-talk between the discharge cells 14, are formed on the first dielectric layer 12 and partition discharge cells 14. Red (R), green (G), and blue (B) fluorescent layers 15 are respectively coated on the inner surfaces of the discharge cells 14 to a predetermined thickness. The discharge cells 14 are filled with a discharge gas.

The upper substrate 20, which transmits visible light, is usually made of glass, and it is coupled to the lower substrate 10 having the barrier ribs 13. Pairs of stripe-shaped sustaining electrodes 21a and 21b are formed on the bottom surface of the upper substrate 20 in a direction substantially orthogonal to the address electrodes 11. The sustaining electrodes 21a and 21b are usually made of a transparent conductive material, such as indium tin oxide (ITO), so that they can transmit visible light. Narrow, metallic bus electrodes 22a and 22b may be formed on the bottom surfaces of the sustaining electrodes 21a and 21b, respectively, to reduce the sustaining electrodes' line resistance. A transparent second dielectric layer 23 covers the sustaining electrodes 21a and 21b and the bus electrodes 22a and 22b. A protective layer 24, which is usually made of magnesium oxide (MgO), covers the second dielectric layer 23.

In the PDP having the above structure, the protective layer 24 prevents damage to the second dielectric layer 23 from sputtering of plasma particles, and it emits secondary electrons to lower a discharge voltage. However, an MgO protective layer's low secondary electron emission coefficient limits its electron-emitting effects.

To overcome this problem, U.S. Pat. No. 6,346,775 describes a PDP, of which cross-section is illustrated in FIG. 3.

Referring to FIG. 3, an upper substrate 40 and a lower substrate 30 face each other with a discharge space formed therebetween. A plurality of barrier ribs 33 divide the discharge space into discharge cells 34. A plurality of address electrodes 31 are formed on the top surface of the lower substrate 30, and a first dielectric layer 32 covers the address electrodes 31. Sustaining electrodes 41 are formed on the bottom surface of the upper substrate 40, and a second dielectric layer 43 covers the sustaining electrodes 41. A secondary electron amplification structure may be formed by sequentially forming a protective layer 44 and carbon nanotubes (CNTs) 45 on the bottom surface of the second dielectric layer 43. The PDP has increased luminous efficiency and brightness, as well as a reduced discharge voltage, due to the secondary electron amplification structure, but there is a possibility that the CNTs 45 may be destroyed during discharging. Additionally, the electron-emitting characteristic of the CNTs 45 may deteriorate in a discharge space maintained under low vacuum atmosphere in the PDP.

### SUMMARY OF THE INVENTION

The present invention provides a plasma display panel (PDP) and a flat lamp using oxidized porous silicon to increase an electron-emitting property.

Additional features of the invention will be set forth in the description which follows, and in part will be apparent from the description, or may be learned by practice of the invention.

The present invention discloses a PDP comprising a first panel and a second panel facing each other, a plurality of address electrodes formed in the first panel, a plurality of is sustaining electrodes formed in the second panel, and an oxidized porous silicon layer formed in the second panel and corresponding to a sustaining electrode.

The present invention also discloses a PDP including an upper substrate and a lower substrate facing each other with a discharge space therebetween, a plurality of address electrodes formed on the lower substrate, a first dielectric layer covering the address electrodes, a plurality of sustaining electrodes formed on the upper substrate and in a direction crossing the address electrodes, a second dielectric layer covering the sustaining electrodes, an oxidized porous silicon layer formed on the second dielectric layer, a plurality of barrier ribs between the upper substrate and the lower substrate and dividing the discharge space into discharge cells, and a fluorescent layer formed on inner walls of the discharge cells.

The present invention also discloses a PDP including an upper substrate and a lower substrate facing each other with a discharge space therebetween, a plurality of address electrodes formed on the lower substrate, a first dielectric layer covering the address electrodes, a plurality of sustaining electrodes formed on the upper substrate and in a direction crossing the address electrodes, an oxidized porous silicon layer formed on a sustaining electrode, a second dielectric layer formed on the upper substrate and exposing the oxidized porous silicon layer, a plurality of barrier ribs between the upper substrate and the lower substrate and dividing the discharge space into discharge cells, and a fluorescent layer formed on inner walls of the discharge cells.

The present invention also discloses a method of manufacturing a PDP, including forming a plurality of sustaining electrodes on a substrate and forming a dielectric layer covering the sustaining electrodes, forming a plurality of base electrodes on the dielectric layer and in a direction substantially parallel to the sustaining electrodes, forming a silicon layer covering the dielectric layer and the base electrodes, forming porous silicon layers from portions of the silicon layer disposed above the base electrodes, oxidizing the porous silicon layers, and removing portions of the silicon layers remaining on the dielectric layer.

The present invention also discloses a method of manufacturing a PDP, including forming a plurality of sustaining electrodes on a substrate and forming a bus electrode on a sustaining electrode, forming a dielectric layer covering the sustaining electrodes and the bus electrode, etching the dielectric layer to form a trench exposing the bus electrode, forming a silicon layer on the exposed bus electrode, changing the silicon layer into a porous silicon layer, and oxidizing the porous silicon layer.

The present invention also discloses a method of manufacturing a PDP, including forming a plurality of sustaining electrodes on a substrate and forming a dielectric layer covering the sustaining electrodes, etching the dielectric layer to form a trench exposing a sustaining electrode, forming a silicon layer on the exposed sustaining electrode, changing the silicon layer into a porous silicon layer, and oxidizing the porous silicon layer.

The present invention also discloses a PDP including an upper substrate and a lower substrate facing each other with a discharge space therebetween, a plurality of first electrodes formed on the lower substrate, a first dielectric layer covering the first electrodes, a plurality of second electrodes formed on the upper substrate and in a direction crossing the first electrodes, a second dielectric layer covering the second electrodes, an oxidized porous silicon layer formed on at least one of the second dielectric layer and the first dielectric layer, the oxidized porous silicon layer corresponding to an electrode, a plurality of barrier ribs between the upper substrate and the lower substrate and dividing the discharge space into discharge cells, and a fluorescent layer formed on inner walls of the discharge cells.

The present invention also discloses a PDP including an upper substrate and a lower substrate facing each other with a discharge space therebetween, a plurality of first electrodes formed on the lower substrate, a plurality of second electrodes formed on the upper substrate and in a direction crossing the first electrodes, an oxidized porous silicon layer formed on either the first electrodes or the second electrodes, a plurality of barrier ribs between the upper substrate and the lower substrate and dividing the discharge space into discharge cells, and a fluorescent layer formed on inner walls of the discharge cells.

The present invention also discloses a flat lamp including an upper panel and a lower panel facing each other, a plurality of discharge electrodes formed in at least one of the upper panel and the lower panel, and an oxidized porous silicon layer formed in a panel in which the discharge electrodes are formed and corresponding to the discharge electrodes.

The present invention also discloses a flat lamp including an upper substrate and a lower substrate facing each other with a discharge space therebetween, a plurality of discharge electrodes formed on an outer surface of at least one of the upper substrate and the lower substrate, and an oxidized porous silicon layer formed on an inner surface of a substrate on which the discharge electrodes are formed, the oxidized porous silicon layer corresponding to a discharge electrode and parallel to the discharge electrode, a plurality of spacers between the upper substrate and the lower substrate and dividing the discharge space into discharge cells, and a fluorescent layer formed on inner walls of the discharge cells.

The present invention also discloses a method of manufacturing a flat lamp, including forming a plurality of discharge electrodes on a bottom surface of a substrate and forming a plurality of base electrodes on the top surface of the substrate, forming a silicon layer covering the top surface of the substrate and the base electrodes, forming porous silicon layers is from portions of the silicon layer disposed above the base electrodes, oxidizing the porous silicon layers, and removing portions of the silicon layer remaining on the substrate.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

FIG. 1 is an exploded perspective view showing a conventional plasma display panel (PDP).

FIG. 2A and FIG. 2B are cross-sectional views showing the PDP of FIG. 1.

FIG. 3 is a cross-sectional view showing another conventional PDP.

FIG. 4 is an exploded perspective view showing a PDP according to an embodiment of the present invention.

FIG. 5 is a cross-sectional view showing a portion of the PDP of FIG. 4.

FIG. 6 is a cross-sectional view showing a portion of a PDP according to another embodiment of the present invention.

FIG. 7A, FIG. 7B, FIG. 7C, FIG. 7D, FIG. 7E, FIG. 7F, and FIG. 7G are views showing a method of manufacturing an upper panel of the PDP of FIG. 4.

FIG. 8A, FIG. 8B, FIG. 8C, FIG. 8D, and FIG. 8E are views showing a method of manufacturing an upper panel of the PDP of FIG. 6.

FIG. 9 is a cross-sectional view showing a portion of a PDP according to still another embodiment of the present invention.

FIG. 10 is a cross-sectional view showing a portion of a PDP according to yet another embodiment of the present invention.

FIG. 11 is a cross-sectional view showing a portion of a PDP according to a further embodiment of the present invention.

FIG. 12 is a cross-sectional view showing a portion of a flat lamp according to an embodiment of the present invention.

FIG. 13A, FIG. 13B, FIG. 13C, FIG. 13D, and FIG. 13E are views showing a method of manufacturing the flat lamp of FIG. 12.

FIG. 14A and FIG. 14B are cross-sectional views showing a conventional flat lamp and a flat lamp according to an embodiment of the present invention, respectively.

FIG. 15 is a voltage vs. pressure graph of a discharge gas for the conventional lamp of FIG. 14A and the flat lamp of FIG. 14B.

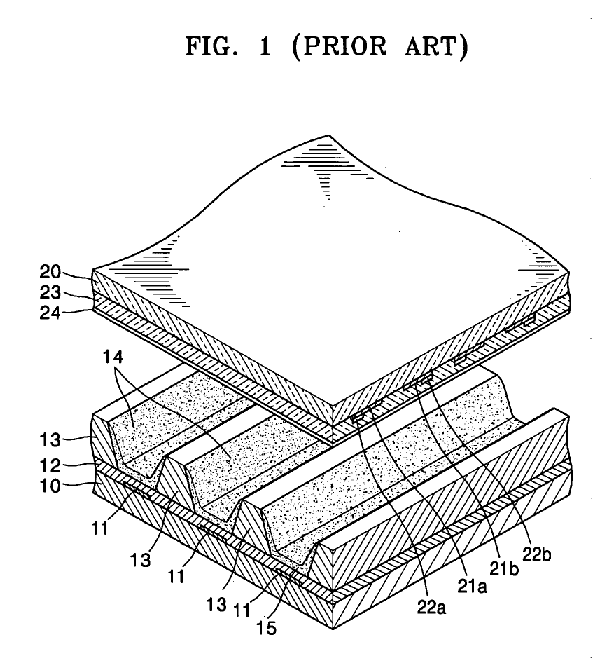

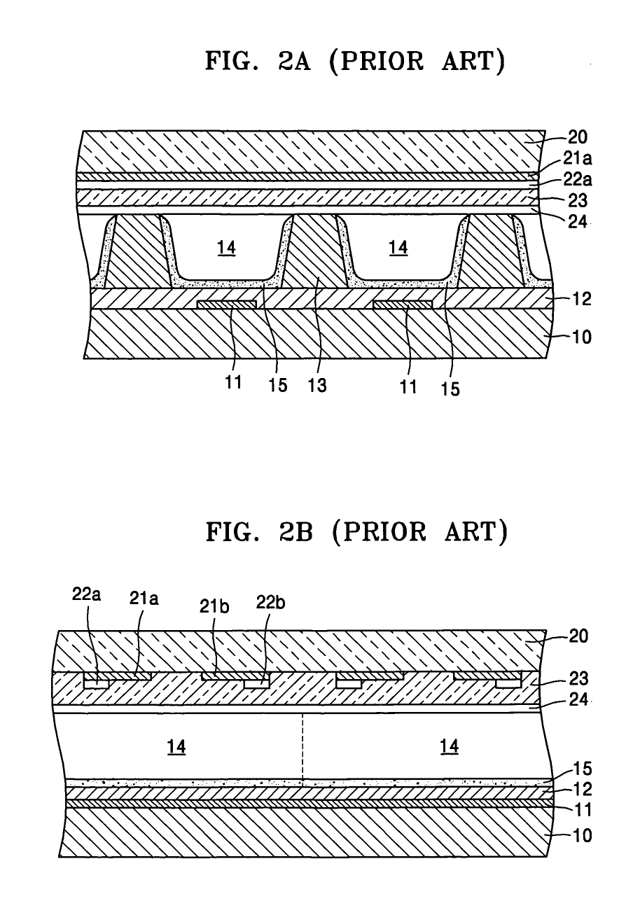

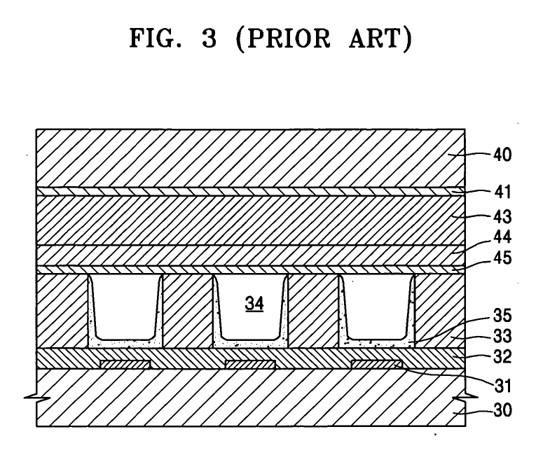

### DETAILED DESCRIPTION OF THE ILLUSTRATED EMBODIMENTS

Hereinafter, exemplary embodiments of the present invention will be described with reference to the attached drawings. Throughout the drawings, the same reference numerals denote the same constitutional elements.

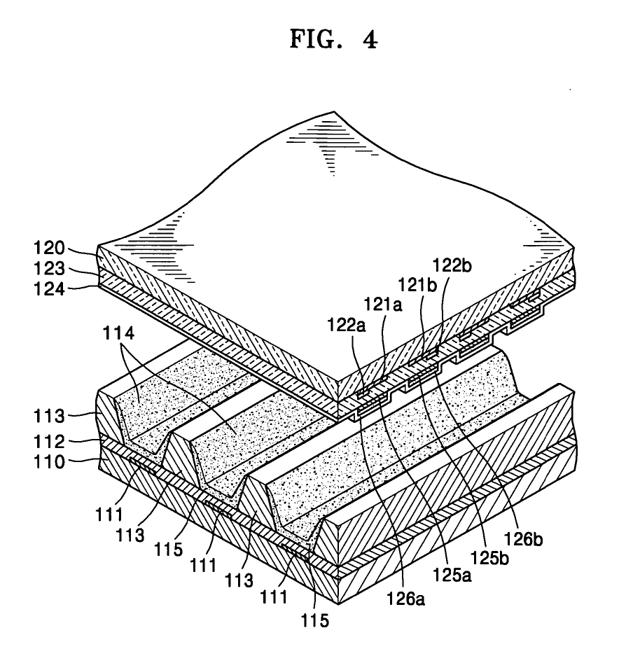

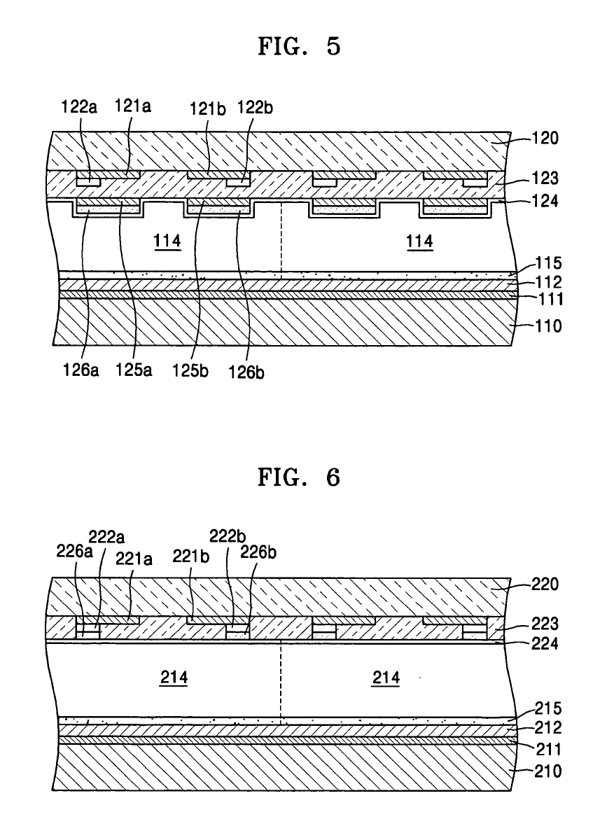

FIG. 4 is an exploded perspective view showing a plasma display panel (PDP) according to an embodiment of the present invention, and FIG. 5 is a cross-sectional view of a portion of the PDP of FIG. 4.

Referring to FIG. 4 and FIG. 5, the PDP according to an embodiment of the present invention may include an upper panel and a lower panel facing each other. A plasma is discharge occurs in a discharge space between the upper panel and the lower panel. A plurality of barrier ribs 113 divide the discharge space into discharge cells 114 and prevent electrical and optical cross-talk between adjacent discharge cells 114. A discharge gas, which generates ultraviolet rays during a discharge, is injected into the discharge cells 114. Generally, a mixed gas of Ne and Xe may be used as the discharge gas. Red (R), green (G), and blue (B) fluorescent layers 115 may be respectively coated on inner surfaces of the discharge cells 114 to a predetermined thickness. The ultraviolet rays excite the fluorescent layers 115, which emit visible light having predetermined colors.

The lower panel may include a lower substrate 110, a plurality of address electrodes 111 formed in parallel to each other on the top surface of the lower substrate 110, and a first dielectric layer 112 covering the address electrodes 111.

The lower substrate 110 may be mainly made of glass, for example.

The barrier ribs 113 are formed on the top surface of the first dielectric layer 112, and the barrier ribs 113 may be parallel to, and between, the address electrodes 111. The barrier ribs may have various configurations. For example, they may be formed perpendicular to the address electrodes 111, or they may be formed in a matrix. The fluorescent layers 115 are formed to a predetermined thickness on exposed portions of the first dielectric layer 112 and the lateral sides of the barrier ribs 113.

The upper panel may include an upper substrate 120, a plurality of first and second sustaining electrodes 121a and 121b formed on the bottom surface of the upper substrate 120, a second dielectric layer 123 covering the first and second sustaining electrodes 121a and 121b, and a plurality of first and second oxidized porous silicon layers 126a and 126b formed below the first and second sustaining electrodes 121a and 121b, respectively.

The upper substrate 120 may be mainly made of glass, for example, so that it can transmit visible light. Pairs of the sustaining electrodes 121a and 121b are formed in parallel on the bottom surface of the upper substrate 120 and in a direction crossing the address electrodes 111. The first and second sustaining electrodes 121a and 121b may be made of a transparent conductive material, such as, for example, indium tin oxide (ITO). First and second bus electrodes 122a and 122b may be formed on the bottom surfaces of the first and second sustaining electrodes 121a and 121b, respectively, to reduce the sustaining electrodes' line resistance. The first and second bus electrodes 122a and 122b may be formed along edges of the first and second sustaining electrodes 121a and 121b and they are narrower than the first and second sustaining electrodes 121a and 121b, respectively. The bus electrodes 122a and 122b may be made of metal, such as, for example, Al or Ag. The second dielectric layer 123, which is transparent, covers the first and second sustaining electrodes 121a and 121b and the first and second bus electrodes 122a and 122b.

A plurality of first and second base electrodes 125a and 125b may be formed on the bottom surface of the second dielectric layer 123 so that they correspond to, and are parallel with, the first and second sustaining electrodes 121a and 121b, respectively. The first and second base electrodes 125a and 125b may be made of, for example, ITO, Al, or Ag.

First and second oxidized porous silicon layers 126a and 126b may be formed on the bottom surfaces of the first and second base electrodes 125a and 125b, respectively. The first and second oxidized porous silicon layers 126a and 126b may be oxidized porous polycrystalline silicon (“polysilicon”) layers or oxidized porous amorphous silicon layers. The first and second oxidized porous silicon layers 126a and 126b may have the same width as the first and second base electrodes 125a and 125b. The first and second oxidized porous silicon layers 126a and 126b may amplify electron emission.

A protective layer 124 may be formed on the bottom surface of the second dielectric layer 123. The protective layer 124 prevents damage to the second dielectric layer 123 from sputtering of plasma particles, and it emits secondary electrons to lower a discharge voltage. The protective layer 124 may be made of, for example, MgO. Alternatively, as FIG. 4 and FIG. 5 show, the protective layer 124 may be also formed on the bottom surfaces of the first and second oxidized porous silicon layers 126a and 126b.

In the PDP having the above structure, applying discharge voltages of 1,000 V and 0 V, for example, to the first and second sustaining electrodes 121a and 121b, respectively, forms an electric field directed from the first sustaining electrode 121a toward the second sustaining electrode 121b in the discharge cells 114. Due to the electric field's formation, electrons flow in the second oxidized porous silicon layer 126b from the second base electrode 125b. The electrons accelerate while passing through the second oxidized porous silicon layer 126b and then emit into the discharge cells 114. On the other hand, when voltages of 0 V and 1,000 V, for example, are applied to the first and second sustaining electrodes 121a and 121b, respectively, electrons flow in the first oxidized porous silicon layer 126a from the first base electrode 125a, and the electrons accelerate while passing through the first oxidized porous silicon layer 126a and are then emitted into the discharge cells 114.

As describe above, when the oxidized porous silicon layers 126a and 126b are formed on the PDP's upper panel, an electron-emitting characteristic may increase, thereby enhancing brightness and luminous efficiency.

FIG. 6 is a cross-sectional view showing a portion of a PDP according to another embodiment of the present invention.

Referring to FIG. 6, an upper panel and a lower panel face each other with a discharge space therebetween. Barrier ribs (not shown) divide the discharge space to form discharge cells 214. Fluorescent layers 215 are coated on the inner surfaces of the discharge cells 214.

The lower panel may include a lower substrate 210, a plurality of address electrodes 211 formed in parallel with each other on the top surface of the lower substrate 210, and a first dielectric layer 212 covering the address electrodes 211.

The upper panel may include an upper substrate 220, first and second sustaining electrodes 221a and 221b formed on the bottom surface of the upper substrate 220, first and second bus electrodes 222a and 222b formed on the bottom surfaces of the first and second sustaining electrodes 221a and 221b, respectively, and first and second oxidized porous silicon layers 226a and 226b formed on the bottom surfaces of the first and second bus electrodes 222a and 222b, respectively.

The first and second sustaining electrodes 221a and 221b are formed in parallel to each other and in a direction crossing the address electrodes 211. The first and second sustaining electrodes 221a and 221b may be made of a transparent conductive material, such as, for example, ITO. The first and second bus electrodes 222a and 222b may be formed on the bottom surfaces of the first and second sustaining electrodes 221a and 221b, respectively, to reduce the sustaining electrodes' line resistance. Further, the first and second bus electrodes 222a and 222b may be formed along edges of the first and second sustaining electrodes 221a and 221b and they are narrower than the first and second sustaining electrodes 221a and 221b, respectively. The bus electrodes 222a and 222b may be made of a metal, such as, for example, Al or Ag.

The first and second oxidized porous silicon layers 226a and 226b may be formed on the bottom surfaces of the first and second bus electrodes 222a and 222b, respectively. The first and second oxidized porous silicon layers 226a and 226b may be oxidized porous polysilicon layers or oxidized porous amorphous silicon layers. The first and second oxidized porous silicon layers 226a and 226b may be formed along the first and second bus electrodes 222a and 222b and have the same width as the first and second bus electrodes 222a and 222b.

A second dielectric layer 223, which is transparent, may be formed on the bottom surface of the upper substrate 220, leaving the bottom surfaces of the first and second oxidized porous silicon layers 226a and 226b exposed. A protective layer 224 may be formed on the bottom surface of the second dielectric layer 223. The protective layer 224 may be made of, for example, MgO. As FIG. 6 shows, the protective layer 224 may be also formed on the bottom surfaces of the first and second oxidized porous silicon layers 226a and 226b.

An alternative structure for this embodiment includes forming the oxidized porous silicon layers 226a and 226b directly on the bottom surfaces of the sustaining electrodes 221a and 221b, without forming the bus electrodes 222a and 222b therebetween. In this case, the oxidized porous silicon layers 226a and 226b may have the same width as the sustaining electrodes 221a and 221b. Further, the second dielectric layer 223 may be formed on the bottom surface of the upper substrate 220, leaving the bottom surfaces of the oxidized porous silicon layers 226a and 226b exposed.

In the PDP having the above structure, the procedures of emission of the accelerated electrons from the oxidized porous silicon layers 226a and 226b are similar to those in the previous embodiment of the present invention. Thus, a detailed description of the procedures is omitted.

Hereinafter, a method of manufacturing the PDP according to an embodiment of is the present invention will be described.

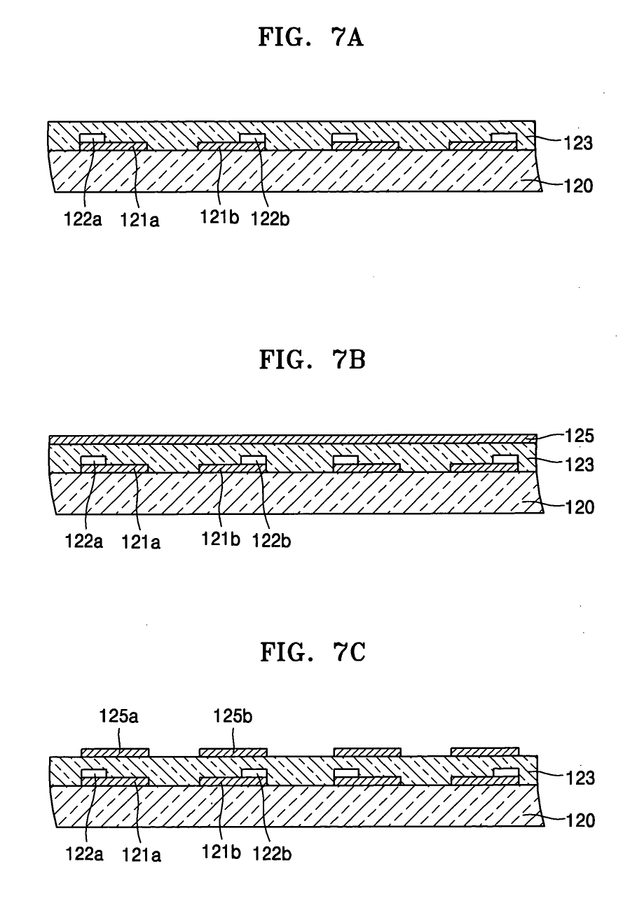

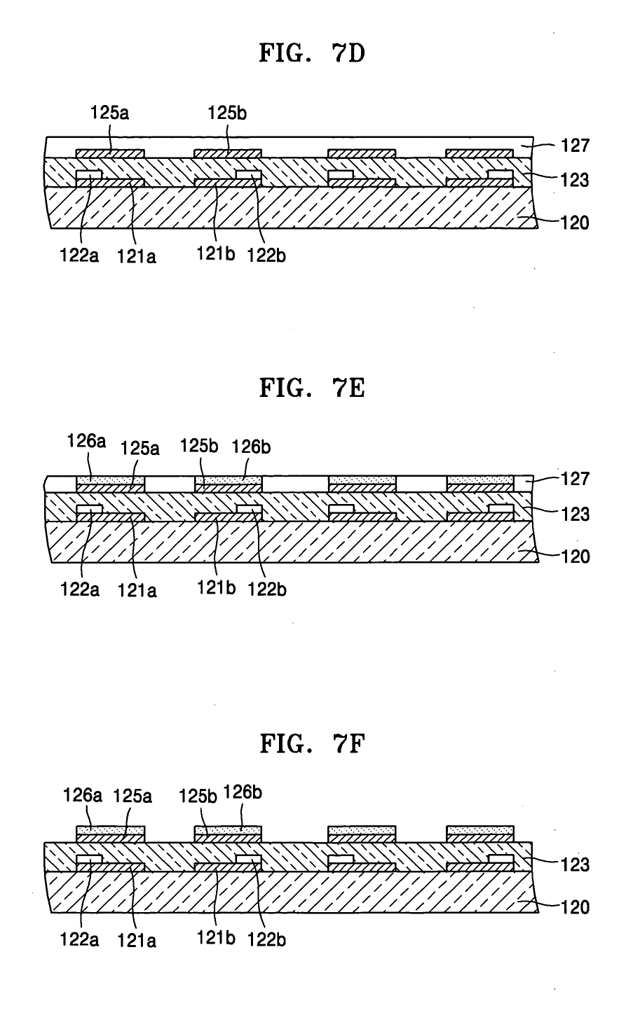

FIG. 7A, FIG. 7B, FIG. 7C, FIG. 7D, FIG. 7E, FIG. 7F, and FIG. 7G are views showing a method of manufacturing the upper panel of the PDP of FIG. 4. In FIGS. 7A, 7B, 7C, 7D, 7E, 7F and 7G, a substrate and a dielectric layer, respectively, correspond to the upper substrate 120 and the second dielectric layer 123 of FIG. 4.

Referring to FIG. 7A, a transparent conductive material, such as ITO, may be deposited on the top surface of the substrate 120 and patterned to form a plurality of first and second sustaining electrodes 121a and 121b. Next, a metallic material, such as Al or Ag, may be deposited on the top surfaces of the first and second sustaining electrodes 121a and 121b and patterned to form a plurality of first and second bus electrodes 122a and 122b. The first and second bus electrodes 122a and 122b may be formed along the edges of the first and second sustaining electrodes 121a and 121b, respectively, and they are narrower than the first and second sustaining electrodes 121a and 121b. Then, the dielectric layer 123 may be formed covering the sustaining electrodes 121a and 121b and the bus electrodes 122a and 122b.

Referring to FIG. 7B, a material for forming the base electrodes 125, such as ITO, Al, or Ag, may be deposited on the top surface of the dielectric layer 123 to a predetermined thickness. Then, as FIG. 7C shows, the material for forming the base electrodes 125 is patterned to a predetermined shape to form the first and second base electrodes 125a and 125b above the first and second sustaining electrodes 121a and 121b, respectively.

Referring to FIG. 7D, a silicon layer 127 may then be formed covering the dielectric layer 123 and the first and second base electrodes 125a and 125b. The silicon layer 127 may be a polysilicon layer or an amorphous silicon layer. Additionally, the silicon layer 127 may be formed to a predetermined thickness at a temperature of about 400° C. or less using plasma enhanced chemical vapor deposition (PECVD), for example.

Referring to FIG. 7E, porous silicon layers may be formed from portions of the silicon layer 127 that are disposed on the base electrodes 125a and 125b. Specifically, the porous silicon layers may be formed by anodizing the silicon layer 127 with a mixed solution of hydrogen fluoride (HF) and ethanol, with predetermined current densities being applied to the first and second base electrodes 125a and 125b. Then, the porous silicon layers may be oxidized using an electrochemical oxidation method. Specifically, a predetermined current density may be applied to the porous silicon layers in an aqueous sulphuric acid solution to obtain the oxidized porous silicon layers 126a and 126b.

Referring to FIG. 7F, portions of the silicon layer 127 remaining on the dielectric layer 123 may be removed. Finally, referring to FIG. 7G, the protective layer 124, which may be made of MgO, may be formed on the top surfaces of the dielectric layer 123 and the oxidized porous silicon layers 126a and 126b. Alternatively, the protective layer 124 may be formed on the top surface of the dielectric layer 123 only. The upper panel obtained in the above process is coupled to the lower panel having the address electrodes to manufacture the PDP.

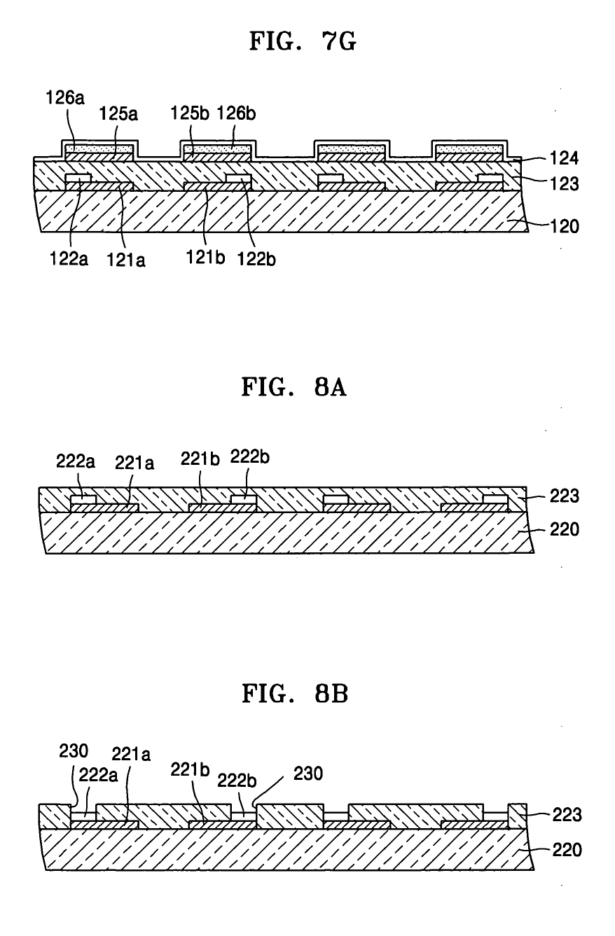

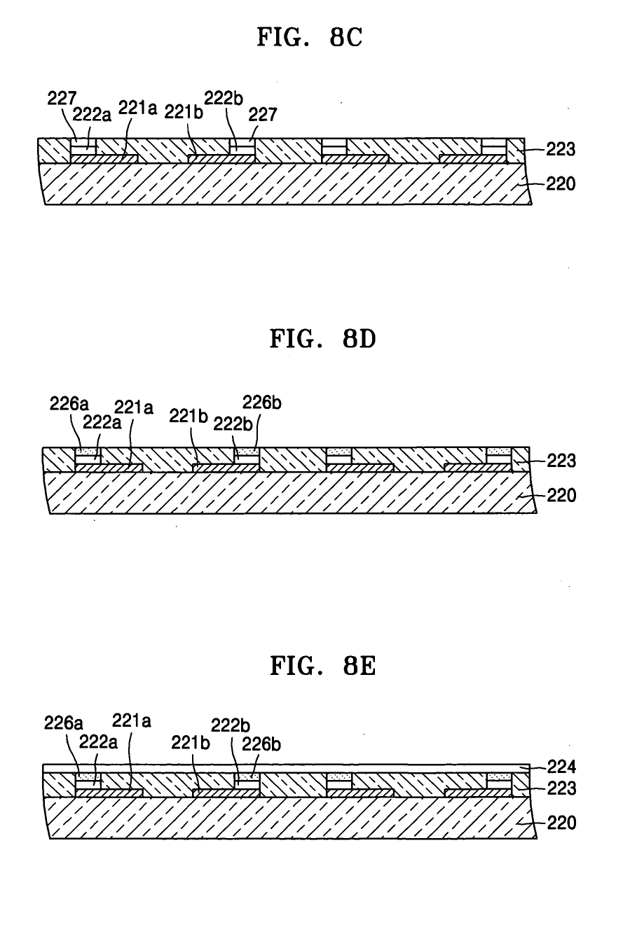

FIG. 8A, FIG. 8B, FIG. 8C, FIG. 8D, and FIG. 8E are views showing a method of manufacturing the upper panel of the PDP of FIG. 6. In FIGS. 8A, 8B, 8C, 8D and 8E, a substrate and a dielectric layer, respectively, correspond to the upper substrate 220 and the second dielectric layer 223 of FIG. 6.

Referring to FIG. 8A, the first and second sustaining electrodes 221a and 221b may be formed on the substrate 220, and the first and second bus electrodes 222a and 222b may be formed on the first and second sustaining electrodes 221a and 221b, respectively. Then, the dielectric layer 223 may be formed covering the sustaining electrodes 221a and 221b and the bus is electrodes 222a and 222b.

Referring to FIG. 8B, the dielectric layer 223 may be etched to form trenches 230 exposing the top surfaces of the first and second bus electrodes 222a and 222b. Then, referring to FIG. 8C, the silicon layers 227 may be formed on the top surfaces of the bus electrodes 222a and 222b. The silicon layers 227 may be polysilicon layers or amorphous silicon layers. The silicon layers 227 may be formed to a predetermined thickness at the temperature of about 400° C. or less using PECVD.

Referring to FIG. 8D, porous silicon layers may be formed from the silicon layers 227 disposed on the bus electrodes 222a and 222b. Specifically, the porous silicon layers may be formed by anodizing the silicon layers 227 with a mixed solution of hydrogen fluoride (HF) and ethanol, with predetermined current densities being applied to the first and second bus electrodes 222a and 222b. Then, the porous silicon layers may be oxidized using an electrochemical oxidation method. Specifically, a predetermined current density may be applied to the porous silicon layers in an aqueous sulphuric acid solution to obtain the oxidized porous silicon layers 226a and 226b.

Finally, referring to FIG. 8E, the protective layer 224, which may be made of MgO, may be formed on the top surfaces of the dielectric layer 223 and the oxidized porous silicon layers 226a and 226b. Alternatively, the protective layer 224 may be formed on the top surface of the dielectric layer 223 only.

On the other hand, although not shown, the oxidized porous silicon layers 226a and 226b may be formed directly on the top surfaces of the sustaining electrodes 221a and 221b, respectively, without forming the bus electrodes 222a and 222b therebetween. In this case, the dielectric layer 223 is etched to expose the entire top surfaces of the sustaining electrodes 221a and 221b, and the silicon layers 227 are formed on the sustaining electrodes 221a and 221b. Hence, the oxidized porous silicon layers 226a and 226b may have the same width as the sustaining electrodes 221a and 221b, respectively, when formed directly on the sustaining electrodes. Then, the silicon layers 227 are changed to the oxidized porous silicon layers 226a and 226b, as described above.

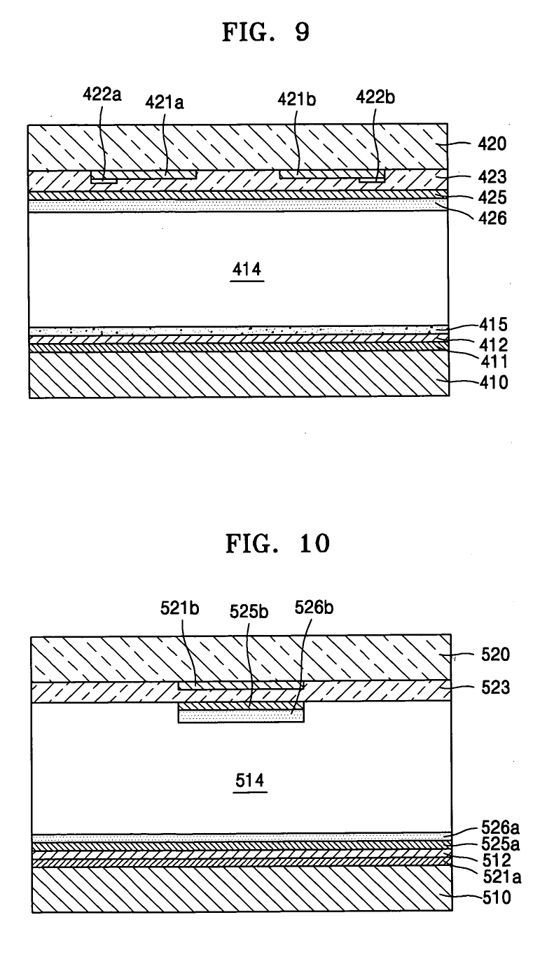

FIG. 9 is a cross-sectional view showing a portion of a PDP according to still another embodiment of the present invention. Referring to FIG. 9, an upper substrate 420 and a lower substrate 410 face each other with a discharge space therebetween. A plurality of barrier ribs (not shown) divides the discharge space into discharge cells 414. Fluorescent layers 415 are coated on the inner surfaces of the discharge cells 414.

A plurality of address electrodes 411 may be formed on the top surface of the lower substrate 410, and a first dielectric layer 412 covers the address electrodes 411. A plurality of first and second sustaining electrodes 421a and 421b may be formed on the bottom surface of the upper substrate 420 and in a direction crossing the address electrodes 411. First and second bus electrodes 422a and 422b are formed on the bottom surfaces of the first and second sustaining electrodes 421a and 421b, respectively. A second dielectric layer 423 covers the first and second sustaining electrodes 421a and 421b and the first and second bus electrodes 422a and 422b.

A base electrode 425 may be formed on the entire bottom surface of the second dielectric layer 423. The base electrode 425 may be made of, for example, ITO, Al, or Ag. The oxidized porous silicon layer 426 may be formed on the entire bottom surface of the base electrode 425. The oxidized porous silicon layer 426 may be an oxidized porous polysilicon layer or an oxidized porous amorphous silicon layer. The oxidized porous silicon layer 426 amplifies an electron emission and functions as a protective layer.

Although the oxidized porous silicon layer is applied to AC surface discharge type PDPs as described above, it can also be applied to AC facing discharge type PDPs.

FIG. 10 is a cross-sectional view showing a portion of a PDP according to yet another embodiment of the present invention. Referring to FIG. 10, an upper substrate 520 and a lower substrate 510 face each other with a discharge space therebetween. A plurality of barrier ribs (not shown) divide the discharge space into discharge cells 514. Fluorescent layers (not shown) are coated on the inner surfaces of the discharge cells 514.

A plurality of first and second electrodes 521a and 521b generate a discharge in the discharge cells 514. The first electrodes 521a may be formed on the top surface of the lower substrate 510, and the second electrodes 521b may be formed on the bottom surface of the upper substrate 520. The first electrodes 521a are formed substantially perpendicular to the second electrodes 521b. A first dielectric layer 512 covers the first electrodes 521a, and a second dielectric layer 523 covers the second electrodes 521b.

A plurality of first base electrodes 525a may be formed on the top surface of the first dielectric layer 512, and they may correspond to, and be parallel with, the first electrodes 521a. A plurality of second base electrodes 525b may be formed on the bottom surface of the second dielectric layer 523, and they may correspond to, and be parallel with, the second electrodes 521b. The first and second base electrodes 525a and 525b may be made of, for example, ITO, Al, or Ag.

The first and second oxidized porous silicon layers 526a and 526b may be formed on the top surfaces of the first base electrodes 525a and the bottom surfaces of the second base electrodes 525b, respectively. The first and second oxidized porous silicon layers 526a and 526b may be oxidized porous polysilicon layers or oxidized porous amorphous silicon layers, and they may have the same width as the first and second base electrodes 525a and 525b. Protective layers made of MgO (not shown) may be further formed on the first dielectric layer 512 and the second dielectric layer 523. The protective layers may cover, or leave exposed, the first and second oxidized porous silicon layers 526a and 526b.

In the PDP having the above structure, when a predetermined AC voltage is applied between the first and second electrodes 521a and 521b, accelerated electrons alternately emit from the first and second oxidized porous silicon layers 526a and 526b, thereby increasing the PDP's brightness and luminous efficiency.

The oxidized porous silicon layer can also be applied to DC PDPs.

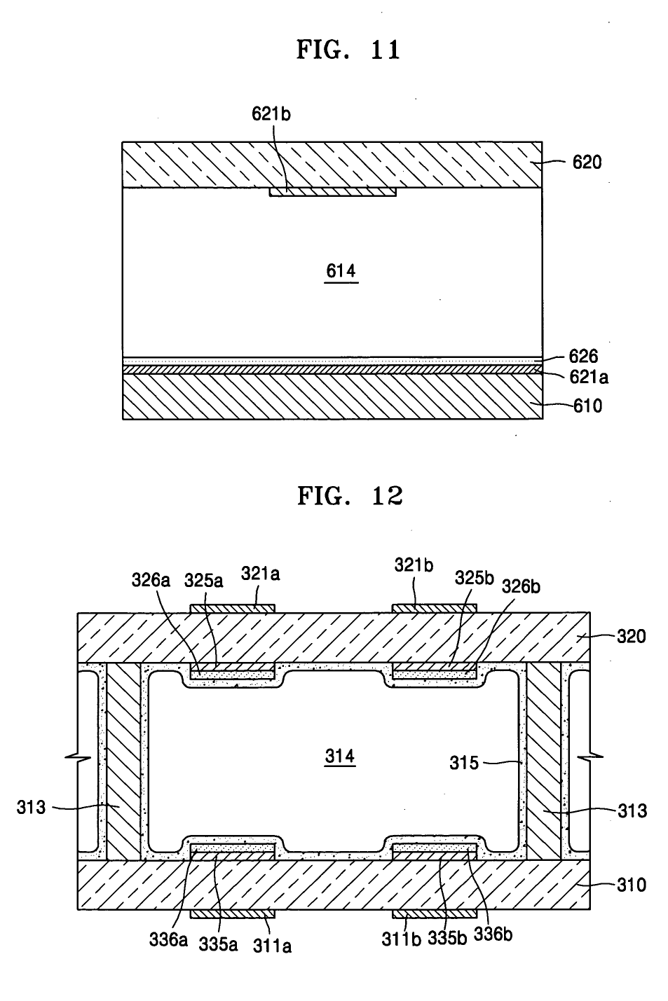

FIG. 11 is a cross-sectional view showing a portion of a PDP according to a further embodiment of the present invention. Referring to FIG. 11, an upper substrate 620 and a lower substrate 610 face each other with a discharge space therebetween. A plurality of barrier ribs (not shown) divide the discharge space into discharge cells 614. Fluorescent layers (not shown) are coated on the inner surfaces of the discharge cells 614.

A plurality of first electrodes 621a may be formed on the top surface of the lower substrate 610. The first electrodes 621a function as cathode electrodes. Oxidized porous silicon layers 626 may be formed on the top surfaces of the first electrodes 621a. The oxidized porous silicon layers 626 may be oxidized porous polysilicon layers or oxidized porous amorphous silicon layers. A plurality of second electrodes 621b may be formed on the bottom surface of the upper substrate 620 and in a direction substantially perpendicular to the first electrodes 621a. The second electrodes 621b function as anode electrodes.

In the PDP having the above structure, when a predetermined voltage is applied between the first electrodes 621a, which are the cathode electrodes, and the second electrodes 621b, which are the anode electrodes, electrons flow from the first electrodes 621a into the oxidized porous silicon layers 626. The electrons accelerate while passing through the oxidized porous silicon layers 626 and are emitted into the discharge cells 614.

On the other hand, the first electrodes 621a may function as anode electrodes, and the second electrodes 621b may function as cathode electrodes. In this case, the oxidized porous silicon layers 626 may be formed on the bottom surfaces of the second electrodes 621b.

The oxidized porous silicon layers capable of increasing the electron-emitting characteristic, as described above, can also be applied to a flat lamp, which may be used as a backlight of an LCD. FIG. 12 is a cross-sectional view showing a flat lamp according to an embodiment of the present invention.

Referring to FIG. 12, the flat lamp according to an embodiment of the present invention may include an upper panel and a lower panel facing each other with a discharge space formed therebetween. A plurality of spacers 313 may be disposed between the upper panel and the lower panel to divide the discharge space into a plurality of discharge cells 314. A discharge gas is injected into the discharge cells 314. Generally, a mixed gas of Ne and Xe is used as the discharge gas. Fluorescent layers 315 may be formed on the inner walls of the discharge cells 314.

The lower panel may include a lower substrate 310, a plurality of first and second discharge electrodes 311a and 311b formed on the bottom surface of the lower substrate 310, a plurality of first and second base electrodes 335a and 335b formed on the top surface of the lower substrate 310, and a plurality of first and second oxidized porous silicon layers 336a and 336b formed on the top surfaces of the first and second base electrodes 335a and 335b, respectively.

The lower substrate 310 may be mainly made of glass, for example. The first and second discharge electrodes 311a and 311b are parallel to, and spaced apart from, each other on the bottom surface of the lower substrate 310. The first and second discharge electrodes 311a and 311b may be made of a conductive material, such as, for example, ITO, Al, or Ag. The first and second base electrodes 335a and 335b may be formed on the top surface of the lower substrate 310, and they may correspond to the first and second discharge electrodes 311a and 311b. The first and second base electrodes 335a and 335b are formed in parallel to the first and second discharge electrodes 311a and 311b. The first and second base electrodes 335a and 335b may be made of a conductive material, such as, for example, ITO, Al, or Ag.

The first and second oxidized porous silicon layers 336a and 336b, which amplify electron emission, may have the same width as the first and second base electrodes 335a and 335b. The first and second oxidized porous silicon layers 336a and 336b may be oxidized porous polysilicon layers or oxidized porous amorphous silicon layers.

The upper panel may include an upper substrate 320, a plurality of third and fourth discharge electrodes 321a and 321b formed on the top surface of the upper substrate 320, a plurality of third and fourth base electrodes 325a and 325b formed on the bottom surface of the upper substrate 320, and a plurality of third and fourth oxidized porous silicon layers 326a and 326b formed on the bottom surfaces of the third and fourth base electrodes 325a and 325b, respectively.

The upper substrate 320 may be mainly made of glass, for example. The third and fourth discharge electrodes 321a and 321b are formed spaced apart from each other by a predetermined distance and in parallel to the first and second discharge electrodes 311a and 311b. The third and fourth discharge electrodes 321a and 321b may be made of a transparent conductive material, such as, for example, ITO. Alternatively, the third and fourth discharge electrodes 321a and 321b may be made of a conductive material, such as, for example, Al or Ag. The third and fourth base electrodes 325a and 325b may be formed on the bottom surface of the upper substrate 320, and they may correspond to, and be parallel with, the third and fourth discharge electrodes 321a and 321b. The third and fourth base electrodes 325a and 325b may be made of a transparent conductive material, such as, for example, ITO. Alternatively, the third and fourth base electrodes 325a and 325b may be made of a conductive material, such as, for example, Al or Ag.

The third and fourth oxidized porous silicon layers 326a and 326b, which amplify electron emission, may have the same width as the third and fourth base electrodes 325a and 325b. The third and fourth oxidized porous silicon layers 326a and 326b may be oxidized porous polysilicon layers or oxidized porous amorphous silicon layers.

In the flat lamp having the above structure, when predetermined voltages are applied to the first and second discharge electrodes 311a and 311b, the electrons accelerated in the first and second oxidized porous silicon layers 336a and 336b emit into the discharge cells 314. When predetermined voltages are applied to the third and fourth discharge electrodes 321a and 321b, the electrons accelerated in the third and fourth oxidized porous silicon layers 326a and 326b emit into the discharge cells 314. This amplified electron emission may increases the flat lamp's brightness and luminous efficiency.

Although a surface discharge type flat lamp having a pair of discharge electrodes formed on the upper panel and on the lower panel is explained in the present embodiment, the present invention is not limited thereto and may be applied to a surface discharge type flat lamp in which a pair of discharge electrodes is formed on either the upper panel or the lower panel. Further, the present invention may be applied to a facing discharge type flat lamp in which first and second discharge electrodes are formed on the upper panel and the lower panel, respectively.

Hereinafter, a method of manufacturing the flat lamp according to an embodiment of the present invention will be described.

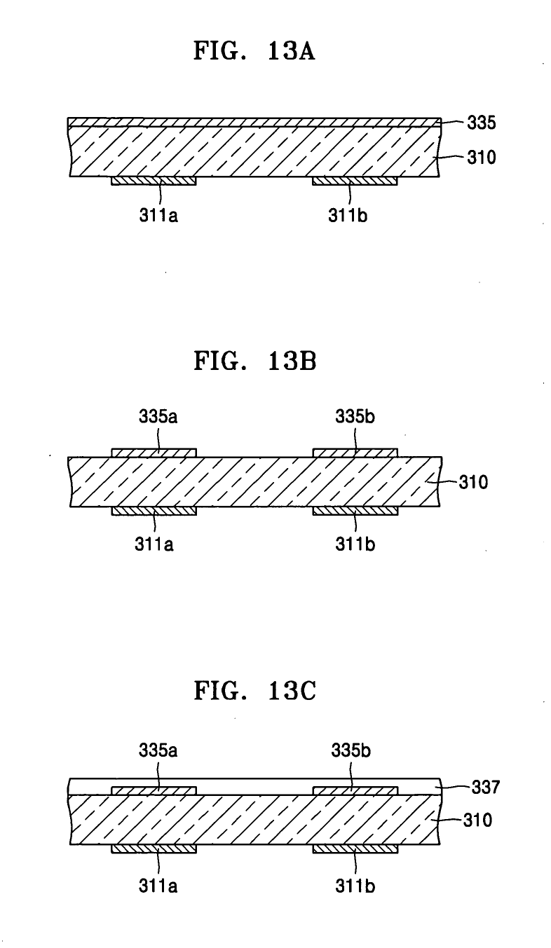

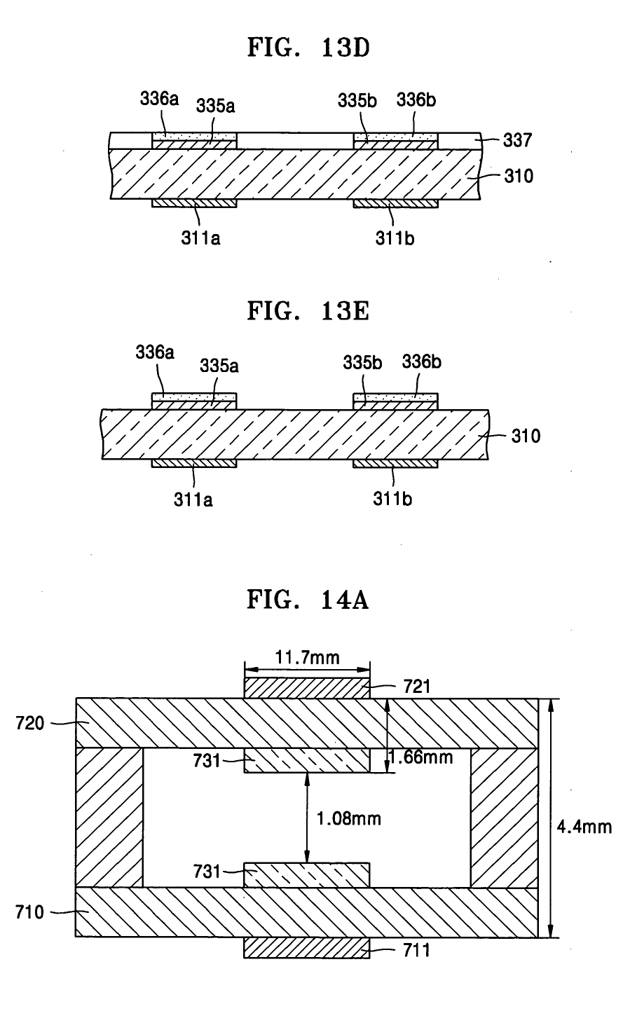

FIG. 13A, FIG. 13B, FIG. 13C, FIG. 13D, and FIG. 13E are views showing a method of manufacturing the lower panel of the flat lamp of FIG. 12. In FIGS. 13A, 13B, 13C, 13D and 13E, a substrate corresponds to the lower substrate of FIG. 12.

Referring to FIG. 13A, a conductive material, such as, for example, ITO, Al, or Ag, may be deposited on the bottom surface of the substrate 310 and patterned to form the first and second discharge electrodes 311a and 311b. Next, a material for forming the base electrodes 335, such as, for example, ITO, Al or Ag, is deposited to a predetermined thickness on the top surface of the substrate 310. Then, as FIG. 13B shows, the material for forming the base electrodes 335 is patterned to a predetermined shape to form the first and second base electrodes 335a and 335b.

Referring to FIG. 13C, a silicon layer 337 may be formed covering the top surface of the substrate 310 and the first and second base electrodes 335a and 335b. The silicon layer 337 may be a polysilicon layer or an amorphous silicon layer. The silicon layer 337 may be formed to a predetermined thickness at the temperature of about 400° C. or less using PECVD.

Referring to FIG. 13D, porous silicon layers may be formed from portions of the silicon layer 337 disposed above the base electrodes 335a and 335b. Specifically, the porous silicon layers may be formed by anodizing the silicon layer 337 with a mixed solution of HF and ethanol, with predetermined current densities being applied to the first and second base electrodes 335a and 335b. Then, the porous silicon layers may be oxidized using an electrochemical oxidation method. Specifically, a predetermined current density may be applied to the porous silicon layers in an aqueous sulphuric acid solution to obtain the oxidized porous silicon layers 336a and 336b.

Referring to FIG. 13E, the portions of the silicon layer 337 remaining on the substrate 310 are removed to obtain the lower panel of the flat lamp of FIG. 12. The upper panel of the flat lamp of FIG. 12 may be manufactured using similar procedures as described above for the lower panel.

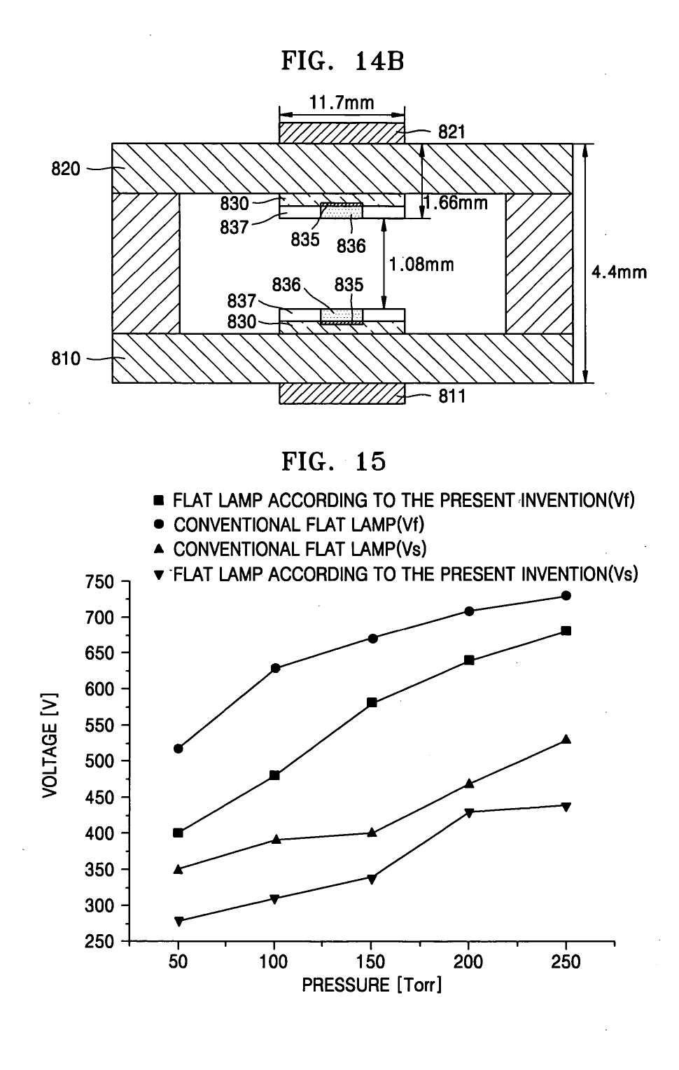

FIG. 14A and FIG. 14B are cross-sectional views showing a conventional flat lamp and a flat lamp according to an embodiment of the present invention, respectively. Both the conventional flat lamp and the flat lamp were used to determine a voltage vs. pressure plot of a discharge gas. In this experiment, a facing discharge type flat lamp was used for convenience of measurement.

Referring to FIG. 14A, discharge electrodes 711 and 721 are formed on the outer surfaces of a lower substrate 710 and an upper substrate 720, respectively, and silicon wafers 731 are formed on the inner surfaces of the lower substrate 710 and the upper substrate 720, respectively, in the conventional flat lamp. Referring to FIG. 14B, discharge electrodes 811 and 821 are formed on the outer surfaces of a lower substrate 810 and an upper substrate 820, respectively, and oxidized porous silicon layers 836 are formed above the inner surfaces of the lower substrate 810 and the upper substrate 820, respectively. Reference numerals 830, 835, and 837 denote substrates, base electrodes, and silicon layers, respectively.

FIG. 15 is a graph showing voltage vs. pressure of a discharge gas for the conventional lamp of FIG. 14A and the flat lamp of FIG. 14B. Referring to FIG. 15, a discharge starting voltage V_{f} and discharge sustaining voltage Vₛ of the flat lamp of FIG. 14B are lower than a discharge starting voltage V_{f} and discharge sustaining voltage Vₛ of the conventional flat lamp of FIG. 14A, respectively.

As described above, the PDP and the flat lamp according to embodiments of the present invention may have the following effects.

First, the PDP and the flat lamp may have increased brightness and luminous efficiency due to oxidized porous silicon layers, which may have an excellent electron-emitting characteristic even at low vacuum condition on a panel.

Second, the PDP and the flat lamp may have a reduced discharge voltage.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A plasma display panel (PDP), comprising:
a first panel and a second panel facing each other;
a plurality of address electrodes formed in the first panel;
a plurality of sustaining electrodes formed in the second panel; and
an oxidized porous silicon layer formed in the second panel and corresponding to a sustaining electrode.

2. The PDP of claim 1, wherein the oxidized porous silicon layer is an oxidized porous polysilicon layer or an oxidized porous amorphous silicon layer.

3. The PDP of claim 1, further comprising:
a base electrode formed in the second panel,
wherein the oxidized porous silicon layer is formed on the base electrode.

4. The PDP of claim 1, wherein a sustaining electrode comprises a bus electrode.

5. A plasma display panel (PDP), comprising:
an upper substrate and a lower substrate facing each other with a discharge space therebetween;
a plurality of address electrodes formed on the lower substrate;
a first dielectric layer covering the address electrodes;
a plurality of sustaining electrodes formed on the upper substrate and in a direction crossing the address electrodes;
a second dielectric layer covering the sustaining electrodes;
an oxidized porous silicon layer formed on the second dielectric layer;
a plurality of barrier ribs between the upper substrate and the lower substrate and dividing the discharge space into discharge cells; and
a fluorescent layer formed on inner walls of the discharge cells.

6. The PDP of claim 5, wherein the oxidized porous silicon layer is an oxidized porous polysilicon layer or an oxidized porous amorphous silicon layer.

7. The PDP of claim 5, wherein the oxidized porous silicon layer is formed on an entire surface of the second dielectric layer.

8. The PDP of claim 5, wherein an oxidized porous silicon layer corresponds to a sustaining electrode and has the same width as the sustaining electrode.

9. The PDP of claim 5, further comprising a base electrode interposed between the oxidized porous silicon layer and the second dielectric layer.

10. The PDP of claim 5, wherein a sustaining electrode comprises a bus electrode.

11. The PDP of claim 5, further comprising a protective layer covering the second dielectric layer and the oxidized porous silicon layer.

12. A plasma display panel (PDP), comprising:
an upper substrate and a lower substrate facing each other with a discharge space therebetween;
a plurality of address electrodes formed on the lower substrate;
a first dielectric layer covering the address electrodes;
a plurality of sustaining electrodes formed on the upper substrate and in a direction crossing the address electrodes;
an oxidized porous silicon layer formed on a sustaining electrode;
a second dielectric layer formed on the upper substrate and exposing the oxidized porous silicon layer;
a plurality of barrier ribs between the upper substrate and the lower substrate and dividing the discharge space into discharge cells; and
a fluorescent layer formed on inner walls of the discharge cells.

13. The PDP of claim 12, wherein the oxidized porous silicon layer is an oxidized porous polysilicon layer or an oxidized porous amorphous silicon layer.

14. The PDP of claim 12, further comprising a bus electrode interposed between the sustaining electrode and the oxidized porous silicon layer.

15. The PDP of claim 14, wherein the bus electrode is formed along an edge of the sustaining electrode, the bus electrode being narrower than the sustaining electrode.

16. The PDP of claim 15, wherein the oxidized porous silicon layer has the same width as the bus electrode.

17. The PDP of claim 12, further comprising a protective layer covering the second dielectric layer and the oxidized porous silicon layer.

18. A method of manufacturing a plasma display panel, comprising:
forming a plurality of sustaining electrodes on a substrate;
forming a dielectric layer covering the sustaining electrodes;
forming a plurality of base electrodes on the dielectric layer and in a direction substantially parallel to the sustaining electrodes;
forming a silicon layer covering the dielectric layer and the base electrodes;
forming porous silicon layers from portions of the silicon layer disposed above the base electrodes;
oxidizing the porous silicon layers; and
removing portions of the silicon layers remaining on the dielectric layer.

19. The method of claim 18, wherein forming the base electrodes comprises depositing a base electrode forming material on the dielectric layer and patterning the base electrode forming material.

20. The method of claim 18, further comprising forming a protective layer covering the dielectric layer and the oxidized porous silicon layers.

21. The method of claim 18, further comprising forming bus electrodes on the sustaining electrodes.

22. The method of claim 18, wherein the silicon layer is a polysilicon layer or an amorphous silicon layer, the silicon layer being deposited by plasma enhanced chemical vapor deposition.

23. The method of claim 18, wherein forming the porous silicon layers comprises anodizing portions of the silicon layer disposed above the base electrodes with a mixed solution of hydrogen fluoride and ethanol.

24. The method of claim 18, wherein oxidizing the porous silicon layers comprises using an electrochemical oxidation method.

25. A method of manufacturing a plasma display panel, comprising:
forming a plurality of sustaining electrodes on a substrate, each sustaining electrode comprising a bus electrode;
forming a dielectric layer covering the sustaining electrodes and the bus electrodes;
etching the dielectric layer to form a trench exposing a bus electrode;
forming a silicon layer on the exposed bus electrode;
changing the silicon layer into a porous silicon layer; and
oxidizing the porous silicon layer.

26. The method of claim 25, further comprising forming a protective layer covering the dielectric layer and the oxidized porous silicon layer.

27. The method of claim 25, wherein the silicon layer is polysilicon layer or an amorphous silicon layer, the silicon layer deposited using plasma enhanced chemical vapor deposition.

28. The method of claim 25, wherein changing the silicon layer into the porous silicon layer comprises anodizing the silicon layer disposed on the bus electrode with a mixed solution of hydrogen fluoride and ethanol.

29. The method of claim 25, wherein oxidizing the porous silicon layer comprises using an electrochemical oxidation method.

30. A method of manufacturing a plasma display panel, comprising:
forming a plurality of sustaining electrodes on a substrate and forming a dielectric layer covering the sustaining electrodes;
etching the dielectric layer to form a trench exposing a sustaining electrode;
forming a silicon layer on the exposed sustaining electrode;
changing the silicon layer into a porous silicon layer; and
oxidizing the porous silicon layer.

31. A plasma display panel (PDP), comprising:
an upper substrate and a lower substrate facing each other with a discharge space therebetween;
a plurality of first electrodes formed on the lower substrate;
a first dielectric layer covering the first electrodes;
a plurality of second electrodes formed on the upper substrate and in a direction crossing the first electrodes;
a second dielectric layer covering the second electrodes;
an oxidized porous silicon layer formed on at least one of the second dielectric layer and the first dielectric layer, the oxidized porous silicon layer corresponding to an electrode;
a plurality of barrier ribs between the upper substrate and the lower substrate and dividing the discharge space into discharge cells; and
a fluorescent layer formed on inner walls of the discharge cells.

32. The PDP of claim 31, wherein the oxidized porous silicon layer is an oxidized porous polysilicon layer or an oxidized porous amorphous silicon layer.

33. The PDP of claim 31, further comprising a base electrode interposed between a dielectric layer and the oxidized porous silicon layer.

34. A plasma display panel (PDP), comprising:
an upper substrate and a lower substrate facing each other with a discharge space therebetween;
a plurality of first electrodes formed on the lower substrate;
a plurality of second electrodes formed on the upper substrate and in a direction crossing the first electrodes;
an oxidized porous silicon layer formed on either a first electrode or a second electrode;
a plurality of barrier ribs between the upper substrate and the lower substrate and dividing the discharge space into discharge cells; and
a fluorescent layer formed on inner walls of the discharge cells.

35. The PDP of claim 34, wherein an electrodes on which the oxidized porous silicon layer is formed is a cathode electrode.

36. The PDP of claim 34, wherein the oxidized porous silicon layer is an oxidized porous polysilicon layer or an oxidized porous amorphous silicon layer.

37. A flat lamp, comprising:
an upper panel and a lower panel facing each other;
a plurality of discharge electrodes formed in at least one of the upper panel and the lower panel; and
an oxidized porous silicon layer formed in a panel in which the discharge electrodes are formed and corresponding to a discharge electrode.

38. The flat lamp of claim 37, wherein the oxidized porous silicon layer is an oxidized porous polysilicon layer or an oxidized porous amorphous silicon layer.

39. The flat lamp of claim 37, further comprising a base electrode contacting the oxidized porous silicon layer.

40. A flat lamp, comprising:
an upper substrate and a lower substrate facing each other with a discharge space therebetween;
a plurality of discharge electrodes formed on an outer surface of at least one of the upper substrate and the lower substrate; and
an oxidized porous silicon layer formed on an inner surface of a substrate on which the discharge electrodes are formed, the oxidized porous silicon layer corresponding to a discharge electrode and parallel to the discharge electrode;
a plurality of spacers between the upper substrate and the lower substrate and dividing the discharge space into discharge cells; and
a fluorescent layer formed on inner walls of the discharge cells.

41. The flat lamp of claim 40, wherein the oxidized porous silicon layer is an oxidized porous polysilicon layer or an oxidized porous amorphous silicon layer.

42. The flat lamp of claim 40, further comprising a base electrode interposed between the oxidized porous silicon layer and the inner surface of the substrate.

43. A method of manufacturing a flat lamp, comprising:
forming a plurality of discharge electrodes on a bottom surface of a substrate;
forming a plurality of base electrodes on a top surface of the substrate;
forming a silicon layer covering the top surface of the substrate and the base electrodes;
forming porous silicon layers from portions of the silicon layer disposed above the base electrodes;
oxidizing the porous silicon layers; and
removing portions of the silicon layer remaining on the top surface of the substrate.

44. The method of claim 43, wherein the base electrodes are formed by depositing a base electrode forming material on the top surface of the substrate and patterning the base electrode forming material.

45. The method of claim 43, wherein the silicon layer is a polysilicon layer or an amorphous silicon layer, the silicon layer being deposited using plasma enhanced chemical vapor deposition.

46. The method of claim 43, wherein forming the porous silicon layers comprises anodizing the portions of the silicon layer disposed above the base electrodes with a mixed solution of hydrogen fluoride and ethanol.

47. The method of claim 43, wherein oxidizing the porous silicon layers comprises using an electrochemical oxidation method.
